(19) United States
(12) Patent Application Publication
(10) Pub. No.: US 2017/0364275 A1
(43) Pub. Date: Dec. 21, 2017

(54) TECHNOLOGIES FOR MANAGING END OF LIFE BEHAVIOR FOR STORAGE DEVICES

(71) Applicant: Intel Corporation, Santa Clara, CA (US)

(72) Inventors: Shankar Natarajan, Santa Clara, CA (US); Arun S. Athreya, Folsom, CA (US); Sanjeev N. Trika, Portland, OR (US)

(21) Appl. No.: 15/186,716

(22) Filed: Jun. 20, 2016

(51) Int. Cl. G06F 3/06

(52) U.S. Cl. CPC G06F 3/0605; G06F 3/0679; G06F 3/0634; G06F 3/0659

(57) ABSTRACT

Technologies for managing end of life behavior of a storage device include an apparatus that includes a memory that includes a plurality of storage cells and a controller to manage read and write operations of the memory. The controller is to determine whether the memory is presently operated in a read-only mode due to a presence of an end of life condition, determine, in response to a determination that the memory is presently operated in the read-only mode and in response to an action of a host, whether to transition the memory to a temporary write mode, and transition, in response to a determination to transition the memory to a temporary write mode, the memory to the temporary write mode. Other embodiments are described and claimed.

### BACKGROUND

Solid state drives (SSDs) used in compute devices are generally designed with a certain percentage of spare capacity, beyond the advertised amount of storage capacity of the drive. This spare capacity is used to compensate for sections of memory that have become unusable after repeated writes and reads from the sections. When the spare capacity becomes depleted below a predefined threshold, the solid state drive enters a read-only mode, as typically required by original equipment manufacturers (OEMs). Such functionality may be required because write activity will wear the non-volatile memory faster and cause the solid state drive to more quickly reach the end of its life. In the read-only mode, the user is expected to read the data from the drive and copy it to another drive before the SSD becomes unusable. In some instances, the transition to read only mode may be problematic. For example, a compute device may issue a write request to each connected drive during a drive identification process. In such scenarios, an SSD that is in read-only mode due to an end of life condition may not perform the write request and, as a result, may not be identified by the compute device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a data storage device that includes a data storage controller for temporarily transitioning a memory of the data storage device from a read-only mode to a temporary write mode during an end of life condition;

FIG. 2 is a simplified block diagram of at least one embodiment of an environment that may be established by a data storage controller included in the data storage device of FIG. 1;

FIGS. 3-5 are a simplified flow diagram of at least one embodiment of a method for managing an operational mode of the memory that may be executed by the data storage device of FIG. 1;

FIG. 6 is a simplified block diagram of at least one embodiment of a compute device including the data storage device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

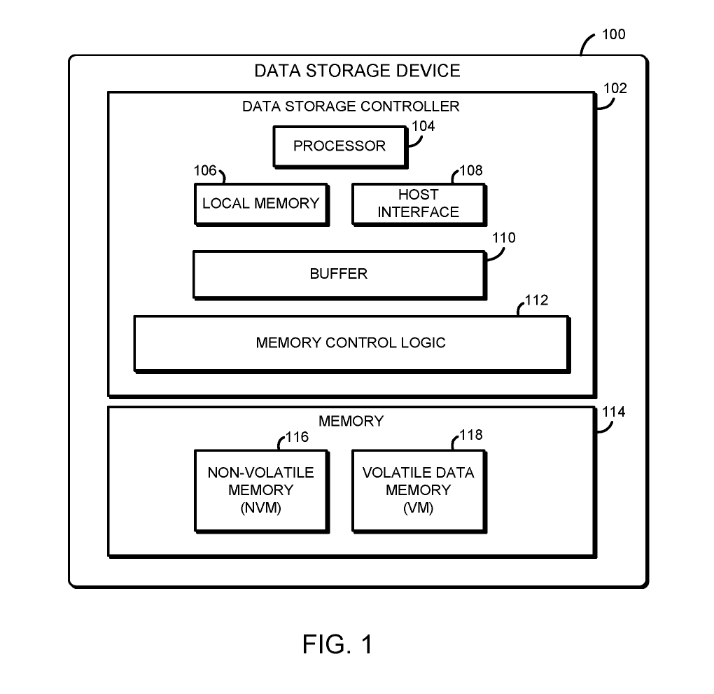

As shown in FIG. 1, an illustrative data storage device 100 for temporarily transitioning from a read-only mode to a temporary write mode during an end of life condition includes a data storage controller 102 and a memory 114, which illustratively includes non-volatile memory 116 and volatile memory 118. In the illustrative embodiment, the data storage controller 102 is configured to determine whether the memory 114 is operated in a read-only mode due the presence of an end of life condition. Additionally, in the illustrative embodiment, the data storage controller 102 is configured to determine, in response to a determination that the memory is presently operated in the read-only mode, and in response to detecting a particular action of a host (i.e., a compute device that issues read and/or write requests to the data storage controller 102), whether to transition the memory 114 to a temporary write mode. In the illustrative embodiment, the action of the host is embodied as a drive identification process, which may occur during a system initialization process (i.e., a system boot), when the drive is coupled to a bus of the host, or in other circumstances. In such embodiments, the data storage controller 102 is configured to transition the memory to the temporary write mode after detecting the above circumstances. By doing so, the data storage controller 102 may perform a write request issued from the host as part of the drive identification process, and the host may successfully identify the drive as a result. In the illustrative embodiment, the data storage controller 102 is configured to transition the memory 114 back to the read-only mode after the action of the host (e.g., the drive identification process) has completed. Further, in some embodiments, these operations performed by the data storage controller 102 are carried out in response to special instructions issued by a driver executed by the host that indicate that the action of the host is occurring and/or that the temporary write mode is to be used.

The data storage device 100 may be embodied as any type device capable of storing data and performing the functions described herein. In the illustrative embodiment, the data storage device 100 is embodied as a solid state drive; however, in other embodiments, the data storage device 100 may embodied as a hard disk drive, a memory module device, a cache memory device, and/or other data storage device.

The data storage controller 102 of the data storage device 100 may be embodied as any type of control device, circuitry, or collection of hardware devices capable of operating the memory 114 in a read-only mode due to an end of life condition and transitioning the memory 114 to a temporary write mode in response to certain actions of the host. In the illustrative embodiment, the data storage controller 102 includes a processor or processing circuitry 104, local memory 106, a host interface 108, a buffer 110, and memory control logic (also referred to herein as a “memory controller”) 112. The memory controller 112 can be in same die or integrated circuit as the processor 104 or the memory 106, 114 or in a separate die or integrated circuit than those of the processor 104 and the memory 106, 114. In some cases, the processor 104, the memory controller 112, and the memory 106, 114 can be implemented in a single die or integrated circuit. Of course, the data storage controller 102 may include additional devices, circuits, and/or components commonly found in a drive controller of a solid state drive in other embodiments.

The processor 104 may be embodied as any type of processor capable of performing the functions described herein. For example, the processor 104 may be embodied as a single or multi-core processor(s), digital signal processor, microcontroller, or other processor or processing/controlling circuit. Similarly, the local memory 106 may be embodied as any type of volatile and/or non-volatile memory or data storage capable of performing the functions described herein. In the illustrative embodiment, the local memory 106 stores firmware and/or other instructions executable by the processor 104 to perform the described functions of the data storage controller 102. In some embodiments, the processor 104 and the local memory 106 may form a portion of a System-on-a-Chip (SoC) and be incorporated, along with other components of the data storage controller 102, onto a single integrated circuit chip.

The host interface 108 may also be embodied as any type of hardware processor, processing circuitry, input/output circuitry, and/or collection of components capable of facilitating communication of the data storage device 100 with a host device or service (e.g., a host application, a driver, etc.). That is, the host interface 108 embodies or establishes an interface for accessing data stored on the data storage device 100 (e.g., stored in the memory 114). To do so, the host interface 108 may be configured to utilize any suitable communication protocol and/or technology to facilitate communications with the data storage device 100 depending on the type of data storage device. For example, the host interface 108 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology in some embodiments.

The buffer 110 of the data storage controller 102 is embodied as volatile memory used by data storage controller 102 to temporarily store data that is being read from or written to the memory 114. The particular size of the buffer 110 may be dependent on the total storage size of the memory 114. The memory control logic 112 is illustratively embodied as hardware circuitry and/or device configured to control the read/write access to data at particular storage locations of memory 114.

The non-volatile memory 116 may be embodied as any type of data storage capable of storing data in a persistent manner (even if power is interrupted to non-volatile memory 116). For example, in the illustrative embodiment, the non-volatile memory 116 is embodied as one or more non-volatile memory devices. The non-volatile memory devices of the non-volatile memory 116 are illustratively embodied as NAND or NOR non-volatile memory devices. However, in other embodiments, the non-volatile memory 116 may be embodied as any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, magnetoresistive random-access memory (MRAM) or Spin Transfer Torque (STT)-MRAM.

The volatile memory 118 may be embodied as any type of data storage capable of storing data while power is supplied to the volatile memory 118. For example, in the illustrative embodiment, the volatile memory 118 is embodied as one or more volatile memory devices, and is periodically referred to hereinafter as volatile memory 118 with the understanding that the volatile memory 118 may be embodied as other types of non-persistent data storage in other embodiments. The volatile memory devices of the volatile memory 118 are illustratively embodied as dynamic random-access memory (DRAM) devices, but may be embodied as other types of volatile memory devices and/or memory technologies capable of storing data while power is supplied to volatile memory 118.

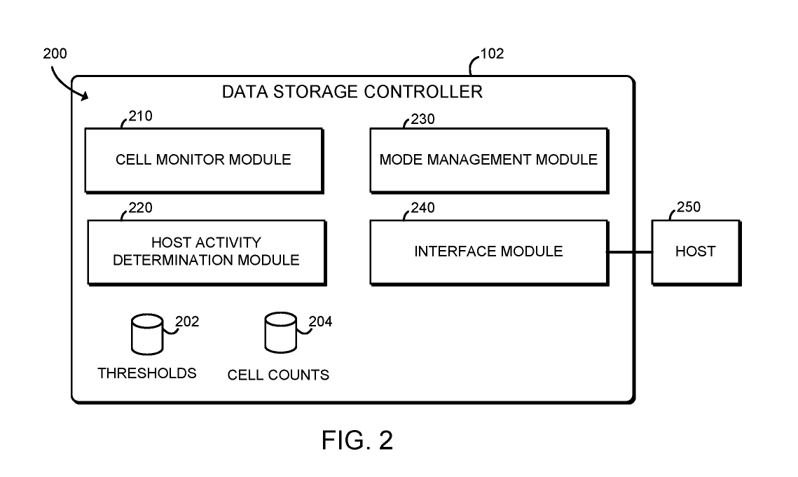

Referring now to FIG. 2, in use, the data storage controller 102 of the data storage device 100 may establish an environment 200. The illustrative environment 200 includes a cell monitor module 210, a host activity determination module 220, a mode management module 230, and an interface module 240. Each of the modules and other components of the environment 200 may be embodied as firmware, software, hardware, or a combination thereof. For example the various modules, logic, and other components of the environment 200 may form a portion of, or otherwise be established by, the data storage controller 102 or other hardware components of the data storage device 100. As such, in some embodiments, any one or more of the modules of the environment 200 may be embodied as a circuit or collection of electrical devices (e.g., a cell monitor circuit 210, a host activity determination circuit 220, a mode management circuit 230, an interface circuit 240, etc.). In the illustrative environment 200, the environment 200 includes thresholds 202 indicative of a number of spare cells (i.e., spare storage capacity) that represent the presence or absence of an end of life condition, and cell counts 204 that are indicative of an amount of spare cells (i.e., spare storage capacity) remaining in the memory 114. The thresholds 202 and the cell counts 204 may be accessed by the various modules and/or sub-modules of the data storage controller 102.

In the illustrative embodiment, the cell monitor module 210, which may be embodied as hardware, firmware, software, virtualized hardware, emulated architecture, and/or a combination thereof as discussed above, is configured to determine whether the memory 114 has reached an end of life condition due, for example, to the amount of spare storage capacity (e.g., cell counts 204) satisfying a predefined threshold 202 (e.g., less than 5% of the total number of cells). The cell monitor module 210 may be configured to query the memory on a periodic basis to determine the cell counts 204 and compare the cell counts to the thresholds 202. Additionally or alternatively, the cell monitor module 210 may be configured to determine an age of the memory 114, such as by determining the present date and comparing the present date to a reference date that is indicative of when the memory 114 was first manufactured or put into operation (i.e., when it began reading and writing data). In the illustrative embodiment, the cell monitor module 210 is configured to communicate with the mode management module 230 to selectively transition between operational modes of the memory 114 based on whether the end of life condition is present.

In the illustrative embodiment, the host activity determination module 220, which may be embodied as hardware, firmware, software, virtualized hardware, emulated architecture, and/or a combination thereof as discussed above, is configured to determine whether a host 250, which may be embodied as an application, service, and/or other device, is performing a predefined action, other than a standard write operation, that would benefit from the data storage device 100 transitioning to a temporary write mode. In the illustrative embodiment, the host activity determination module 220 is configured to determine whether the host 250 has performed a power cycle, which may be a precursor to a drive identification process, or is presently performing a drive identification process. In the illustrative embodiment, the host 250 may be unable to identify the data storage device 100 unless the data storage device 100 successfully performs a write request issued from the host 250 during the drive identification process. In some embodiments, the host activity determination module 220 may receive a write request from the host with an indicator that indicates that the write request is associated with a drive identification process. In such embodiments, the host activity determination module 220 is configured to detect the indicator in the write request and determine that the host 250 is performing a drive identification process. In other embodiments, the host activity determination module 220 is configured to determine that the first write request received from the host 250 after a power cycle has occurred is associated with a drive enumeration process. In the illustrative embodiment, the host activity determination module 220 is configured to communicate with the mode management module 230 to selectively transition between operational modes of the memory 114 based on the activity of the host 250.

In the illustrative embodiment, the mode management module 230, which may be embodied as hardware, firmware, software, virtualized hardware, emulated architecture, and/or a combination thereof as discussed above, is configured to selectively operate the memory 114 in a read mode, a write mode, or a temporary write mode, based on information from the cell monitor module 210, the host activity determination module 220, and the interface module 240, described below. In the illustrative embodiment, if the cell monitor module 210 indicates that the data storage device 100 is not experiencing an end of life condition, and the host activity determination module 220 or the interface module 240 indicate that the host 250 has issued a write request, the mode management module 230 is configured to transition the memory 114 to a write mode in order to fulfill the write request. However, if the cell monitor module 210 indicates that the data storage device 100 is experiencing an end of life condition, the mode management module 230 is, in the illustrative embodiment, configured to operate the memory 114 in a read-only mode, in order to reduce wear on the remaining storage capacity. Further, if the cell monitor module 210 indicates that the data storage device 100 is experiencing an end of life condition and the host activity determination module 220 indicates that the host 250 is performing or is about to perform an operation that would benefit from a write operation, the mode management module 230 is configured, in the illustrative embodiment, to transition the memory 114 to a temporary write mode in which the data storage controller 102 will perform one or more write requests received by the interface module 240 from the host 250, until the host activity determination module 220 indicates that the host's activity is complete.

In the illustrative embodiment, the interface module 240, which may be embodied as hardware, firmware, software, virtualized hardware, emulated architecture, and/or a combination thereof as discussed above, is configured to handle write requests and read requests received from the host 250. To do so, the interface module 240 may be configured to identify a received request and any data or parameters associated with the request, and transmit these items to host activity determination module 220 and/or the mode management module 230. In response to a read request, the interface module 240 may be configured to transmit data read from the memory 114 to the host 250. In response to a write request, the interface module 240 may be configured to transmit a result of the request to the host 250, for example a confirmation that the write request was received and/or completed. As described in more detail herein, the interface module 240 may transmit a confirmation that data was written to the memory 114 in response to a write request when, in fact, the data was only written to the buffer 110, to volatile memory 118, or was otherwise written in a manner that did not fully commit the data to the non-volatile memory 116 (i.e., written without performing a context save).

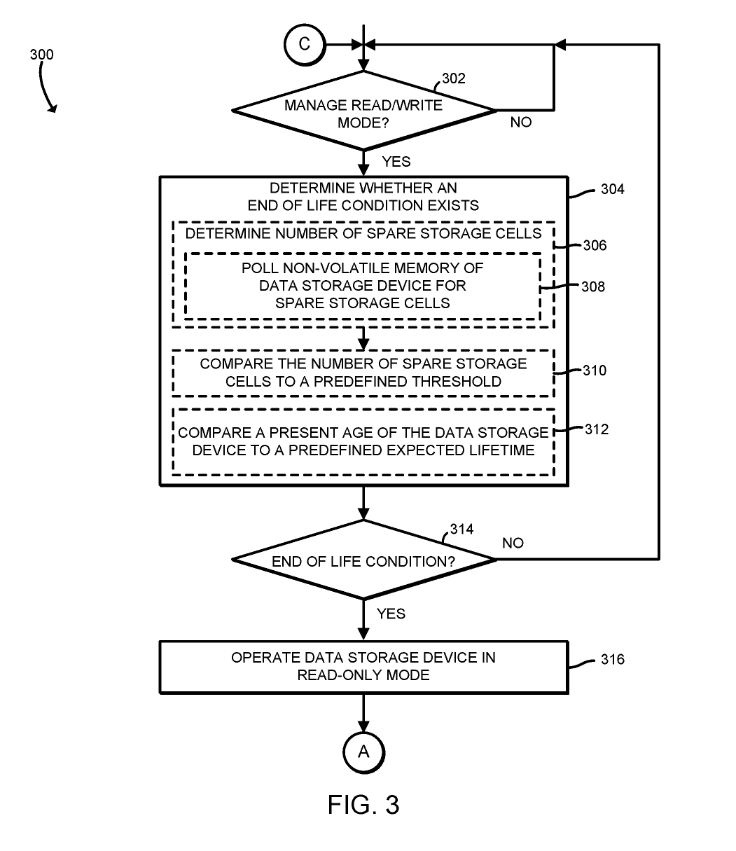

Referring now to FIG. 3, in use, the data storage controller 102 of the data storage device 100 may execute a method 300 for managing an operational mode of the memory 114. The method 300 begins with block 302 in which the data storage controller 102 determines whether to manage the read or write mode of the memory 114. In the illustrative embodiment, the data storage controller 102 continually manages the mode of the memory 114 as long as the data storage device 100 is receiving power. In some embodiments, the data storage controller 102 determines to manage the mode of the memory 114 in response to a predefined triggering event, such as a scheduled self-evaluation process, or other event. Regardless, if the data storage controller 102 determines to manage the read or write mode of the memory 114, the method 300 advances to block 304, in which the data storage controller 102 determines whether an end of life condition exists. As indicated in block 306, the data storage controller 102 may determine a number of spare storage cells (i.e., spare storage capacity) available in the memory 114. In doing so, the data storage controller 102 may poll the non-volatile memory 116 to determine the number of spare (i.e., unused) storage cells. In block 310, the data storage controller 102 may compare the number of spare storage cells to a predefined threshold (i.e., the predefined threshold 202). The threshold may be a number of spare storage cells, a percentage of the total number of storage cells, or other indicator of an amount of spare storage capacity that should be available in order for the data storage device to not be in the end of life condition. As indicated in block 312, the data storage controller 102 may compare a present age of the data storage device to a predefined expected lifetime. In doing so, the data storage controller 102 may determine the present age by comparing a date of manufacture or a date that the data storage device 100 was initially put into operation (i.e., fulfilling read and/or write requests) to a present date. In comparing the present age to the expected lifetime, the data storage controller 102 may determine whether the present age is within a predefined length of time of the expected lifetime (e.g., 5%, two months, etc.). Additionally or alternatively, the data storage controller 102 may reference a predefined table that correlates ages with estimated amounts of spare storage capacity (e.g., spare storage cells) and make the determination of whether the end of life condition is present, based on the determined number of spare storage cells, as described above.

In block 314, the data storage controller 102 determines whether an end of life condition exists, based on the analysis above. If the end of life condition does not exist, then the method loops back to block 302 to again determine whether to manage the operational mode of the data storage device 100. In other words, the data storage device 100 will operate in a read mode in response to a read request and will operate in a write mode in response to a write request. If the end of life condition does exist, the method 300 advances to block 316 in which the data storage controller 102 operates the data storage device 100, and more particularly the memory 114, in a read-only mode. In the illustrative embodiment, the data storage controller 102 does so by setting an indicator in the local memory 106 that the data storage device 100 should generally not fulfill write requests due to the end of life condition.

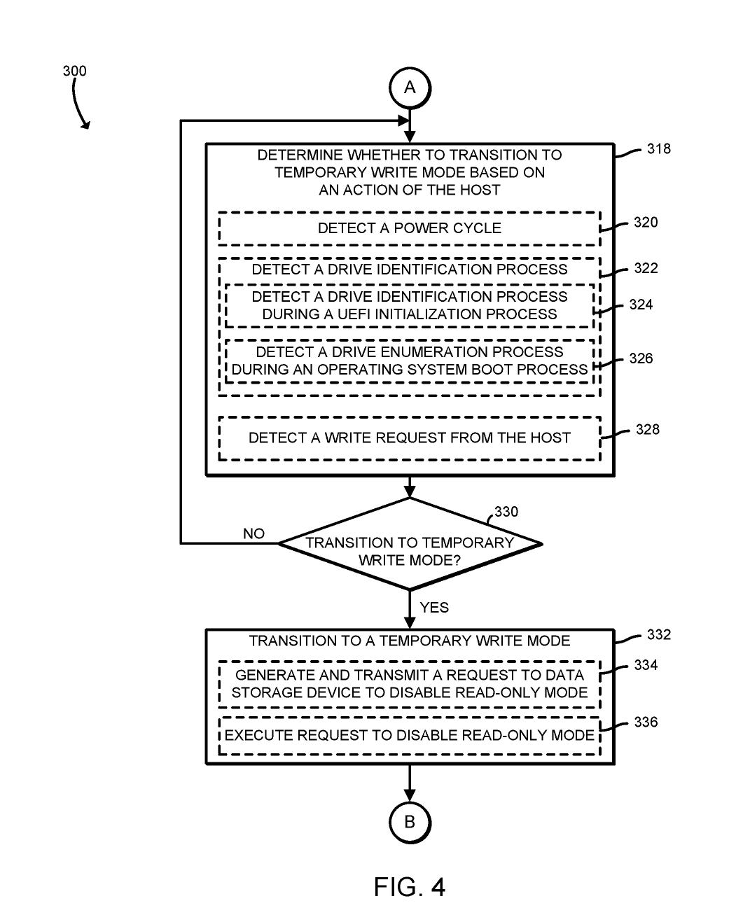

Referring now to FIG. 4, after performing block 316 to operate the data storage device 100 in a read-only mode, the data storage controller 102 determines whether to transition to a temporary write mode based on an action of the host 250, as indicated in block 318. In doing so, as indicated in block 320, the data storage controller 102 may detect that a power cycle has occurred in the host 250 and/or the data storage device 100, which is generally a precursor to a drive identification process. As indicated in block 322, the data storage controller 102 may detect a drive identification process. As an example, the data storage controller 102 may determine that communication from the host within a predefined period after a power cycle is related to a drive identification process. Additionally or alternatively, the data storage controller 102 may receive a notification from the host 250, such as from a driver, that the drive identification process is being performed. As indicated in block 324, the data storage controller 102 may determine that the drive identification process is being performed during a unified extensible firmware interface (UEFI) initialization process, or that a drive enumeration process is being performed during an operating system (e.g., Microsoft Windows) boot process, as indicated in block 326.

In determining whether to transition to the temporary write mode, the data storage controller 102 may detect a write request from the host, as indicated in block 328. The data storage controller 102 may distinguish the write request associated with the drive identification process from other write requests based on whether the write request was issued during a predefined time of the power cycle or based on other indications that the drive identification process is being performed, such as by detecting an indicator in the write request that was generated by a driver operating on the host 250 to indicate that the drive enumeration process, or another process that would benefit from a temporary write mode, is being performed. In block 330, the data storage controller 102 determines, based on the above analysis, whether to transition to the temporary write mode. If the data storage controller 102 determines not to transition the data storage device 100 (i.e., the memory 114) to the temporary write mode, the data storage device 100 remains in its present mode (i.e., the read-only mode) and the method 300 loops back to block 318 to again determine whether to transition to the temporary write mode. Otherwise, the method 300 advances to block 332 in which the data storage controller 102 transitions the data storage device 100 to the temporary write mode.

In some embodiments, at least a portion of the method 300 is performed by the host 250, such as a driver executed by the host 250. In such embodiments, the host 250 may generate and transmit a request to the data storage device 100 to disable the read-only mode and, in response, the data storage controller 102 executes the request to disable the read-only mode. In other embodiments, the data storage controller 102 does not receive such an explicit request and instead makes the determination to transition to the temporary write mode using the analysis described above.

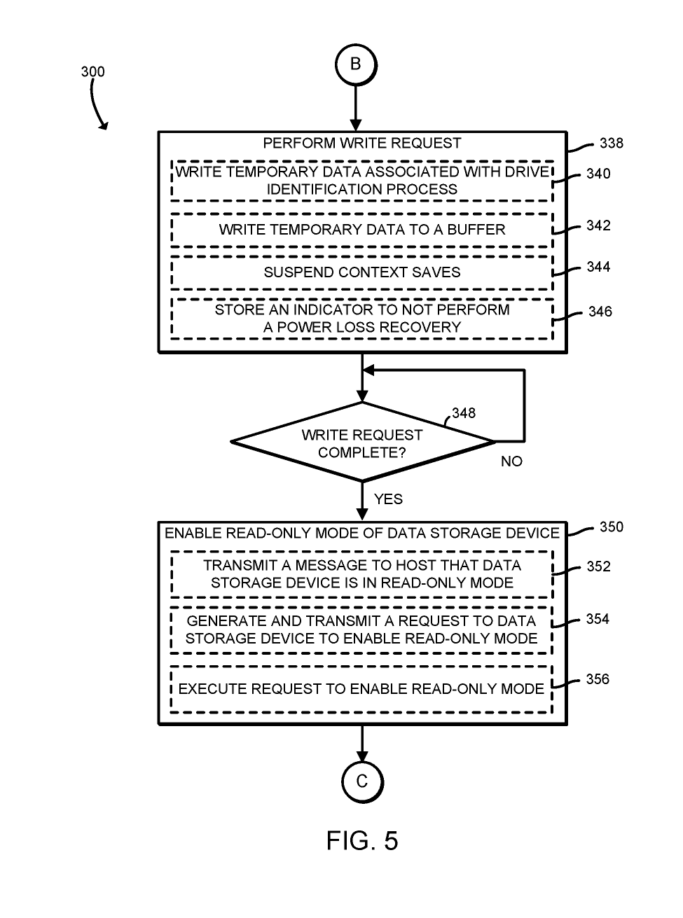

Referring now to FIG. 5, after transitioning the data storage device 100 to the temporary write mode, the data storage controller 102 performs (i.e., fulfills) a write request, as indicated in block 338. In doing so, as indicated in block 340, the data storage controller 102 may write temporary data associated with the drive identification process. As indicated in block 342, the data storage controller 102 may write temporary data to the buffer 110, without writing the data to the non-volatile memory 116. In block 344, the data storage controller 102 may suspend context saves to prevent any written data from being retained after a subsequent power cycle. Additionally or alternatively, the data storage controller 102 may store an indicator to not perform a power loss recovery process for the data associated with the write request. By storing such an indicator, the temporarily written data would not be retained after a power cycle. In block 348, the data storage controller 102 determines whether the write request is complete, indicating the completion of the data storage device's assistance in the activity of the host 250 (e.g., a drive identification process) that initially prompted the transition to the temporary write mode. The data storage controller 102 may receive a notification from the host 250 that the activity has been completed, or the data storage controller 102 may determine that the activity has been completed after a predefined time period has elapsed or after a predefined set of a data associated with the write command has been received from the host 250. It should be understood that the write request may be embodied as a request to write multiple items of data, rather than just one. Regardless, the data storage controller 102 determines whether the one or more writes are complete. If the one or more writes have not yet completed, the method 300 loops back to again determine whether the writes are complete. Once the writes have been completed, the method 300 advances to block 350, in which the data storage controller 102 enables the read-only mode of the data storage device 100.

As indicated in block 352, the data storage controller 102 may transmit a message to the host that the data storage device has transitioned to a read-only mode. In embodiments in that include a specialized driver executed in the host 250 to handle the temporary write modes, the driver (i.e., the host 250) may generate and transmit a request to the data storage device 100 to enable the read-only mode, as indicated in block 354, and in response, the data storage controller 102 may execute the request to enable the read-only mode, as indicated in block 356.

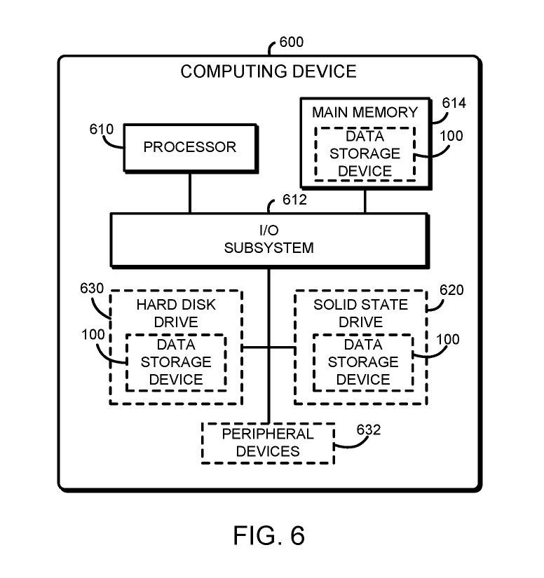

Referring now to FIG. 6, in some embodiments, the data storage device 100 may be incorporated in, or form a portion of, a computing device or other apparatus 600. The computing device 600 may be embodied as any type of computing device in which the data storage device 100 may be used. For example, the computing device 600 may be embodied as a smart phone, a tablet computer, a notebook, a laptop computer, a netbook, an Ultrabook™, a wearable computing device, a pair of smart glasses, a head-mounted computing device, a cellular phone, a desktop computer, a smart device, a personal digital assistant, a mobile Internet device, a server, a data storage device, and/or any other computing/communication device. As shown in FIG. 6, the illustrative computing device 600 includes a processor 610, an input/output (“I/O”) subsystem 612, and a main memory 614. Of course, the computing device 600 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 614, or portions thereof, may be incorporated in the processor 610 in some embodiments.

The processor 610 may be embodied as any type of processor capable of performing the functions described herein. For example, the processor 610 may be embodied as a single or multi-core processor(s), digital signal processor, microcontroller, or other processor or processing/controlling circuit. Similarly, the memory 614 may be embodied as any type of volatile or non-volatile memory or data storage capable of performing the functions described herein. In operation, the memory 614 may store various data and software used during operation of the computing device 600 such as operating systems, applications, programs, libraries, and drivers. The memory 614 is communicatively coupled to the processor 610 via the I/O subsystem 612, which may be embodied as circuitry and/or components to facilitate input/output operations with the processor 610, the memory 614, and other components of the computing device 600. For example, the I/O subsystem 612 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

As shown in FIG. 6, the data storage device 100 may be incorporated in, or form a portion of, one or more other components of the computing device 600. For example, the data storage device 100 may be embodied as, or otherwise be included in, the main memory 614. Additionally or alternatively, the data storage device 100 may be embodied as, or otherwise included in, a solid state drive 620 of the computing device 600. Further, in some embodiments, the data storage device 100 may be embodied as, or otherwise included in, a hard disk drive 630 of the computing device 600. Of course, in other embodiments, the data storage device 100 may be included in or form a portion of other components of the computing device 600.

Reference to memory devices can apply to different memory types, and in particular, any memory that has a bank group architecture. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR4 (DDR version 4, initial specification published in September 2012 by JEDEC), DDR4E (in development by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

In addition to, or alternatively to, volatile memory, in one embodiment, reference to memory devices can refer to a nonvolatile memory device whose state is determinate even if power is interrupted to the device.

### EXAMPLES

Illustrative examples of the technologies disclosed herein are provided below. An embodiment of the technologies may include any one or more, and any combination of, the examples described below.

Example 1 includes an apparatus comprising a memory that includes a plurality of storage cells; and a controller to manage read and write operations of the memory, wherein the controller is to determine whether the memory is presently operated in a read-only mode due to a presence of an end of life condition determine, in response to a determination that the memory is presently operated in the read-only mode and in response to an action of a host, whether to transition the memory to a temporary write mode; and transition, in response to a determination to transition the memory to a temporary write mode, the memory to the temporary write mode.

Example 2 includes the subject matter of Example 1, and wherein the action of the host is a drive identification process, and the controller is further to determine whether the drive identification process has completed; and enable, in response to a determination that the drive identification process has completed, the read-only mode.

Example 3 includes the subject matter of any of Examples 1 and 2, and wherein the controller is further to transmit a message to the host that the memory is in the read-only mode in response to the determination that the drive identification process has completed.

Example 4 includes the subject matter of any of Examples 1-3, and wherein the activity of the host is a drive identification process, and controller is further to receive a write request associated with the drive identification process performed by the host; and determine, in response to the write request, that the host is to perform the drive identification process.

Example 5 includes the subject matter of any of Examples 1-4, and wherein the controller is further to write temporary data to the memory in response to the write request associated with the drive identification process.

Example 6 includes the subject matter of any of Examples 1-5, and wherein the memory is non-volatile memory, the apparatus further comprising a buffer, wherein the controller is further to write temporary data to the buffer in response to the write request associated with the drive identification process.

Example 7 includes the subject matter of any of Examples 1-6, and wherein the controller is further to write temporary data to the memory in response to the write request associated with the drive identification process; suspend context saves; and store an indicator to not perform a power loss recovery, after the temporary data is written.

Example 8 includes the subject matter of any of Examples 1-7, and wherein to the controller is further to determine whether a power cycle has occurred; and determine, in response to a determination that the power cycle has occurred, that the host is to perform a drive identification process.

Example 9 includes the subject matter of any of Examples 1-8, and wherein to determine whether the memory is to operate in a read-only mode due to a presence of an end of life condition comprises to determine a number of spare storage cells available in the memory; compare the determined number of spare storage cells to a predefined threshold number of spare storage cells; and determine, in response to a determination that the number of spare storage cells does not satisfy the predefined threshold number of spare storage cells, that the memory is to operate in the read-only mode.

Example 10 includes the subject matter of any of Examples 1-9, and wherein to determine the number of spare storage cells available in the memory comprises to poll the memory for the number of spare storage cells.

Example 11 includes the subject matter of any of Examples 1-10, and wherein to determine the number of spare storage cells available in the memory comprises to determine a present age of the memory; compare the present age of the memory to a predefined expected lifetime; and determine the number of spare storage cells based on the comparison of the present age of the memory to the predefined expected lifetime.

Example 12 includes the subject matter of any of Examples 1-11, and wherein the memory is non-volatile memory.

Example 13 includes the subject matter of any of Examples 1-12, and wherein the memory is NAND memory.

Example 14 includes the subject matter of any of Examples 1-13, and wherein the apparatus is a non-primary drive of the host.

Example 15 includes a method comprising determining, by a controller of an apparatus, whether a memory of the apparatus is presently operated in a read-only mode due to a presence of an end of life condition; determining, by the controller and in response to a determination that the memory is presently operated in the read-only mode and in response to an action of a host, whether to transition the memory to a temporary write mode; and transitioning, by the controller and in response to a determination to transition the memory to a temporary write mode, the memory to the temporary write mode.

Example 16 includes the method of Example 15, wherein the action of the host is a drive identification process, the method further comprising determining, by the controller, whether the drive identification process has completed; and enabling, by the controller and in response to a determination that the drive identification process has completed, the read-only mode.

Example 17 includes the subject matter of any of Examples 15 and 16, and further comprising transmitting, by the controller, a message to the host that the memory is in the read-only mode in response to the determination that the drive identification process has completed.

Example 18 includes the subject matter of any of Examples 15-17, and wherein the activity of the host is a drive identification process, the method further comprising receiving, by the controller, a write request associated with the drive identification process performed by the host; and determining, by the controller and in response to the write request, that the host is to perform the drive identification process.

Example 19 includes the subject matter of any of Examples 15-18, and further comprising writing, by the controller, temporary data to the memory in response to the write request associated with the drive identification process.

Example 20 includes the subject matter of any of Examples 15-19, and wherein the memory is non-volatile memory and the apparatus further includes a buffer, the method further comprising writing, by the controller, temporary data to the buffer in response to the write request associated with the drive identification process.

Example 21 includes the subject matter of any of Examples 15-20, and further comprising writing, by the controller, temporary data to the memory in response to the write request associated with the drive identification process; suspending, by the controller, context saves; and storing, by the controller, an indicator to not perform a power loss recovery, after the temporary data is written.

Example 22 includes the subject matter of any of Examples 15-21, and further comprising determining, by the controller, whether a power cycle has occurred; and determining, by the controller and in response to a determination that the power cycle has occurred, that the host is to perform a drive identification process.

Example 23 includes the subject matter of any of Examples 15-22, and wherein determining whether the memory is to operate in a read-only mode due to a presence of an end of life condition comprises determining, by the controller, a number of spare storage cells available in the memory; comparing, by the controller, the determined number of spare storage cells to a predefined threshold number of spare storage cells; and determining, by the controller and in response to a determination that the number of spare storage cells does not satisfy the predefined threshold number of spare storage cells, that the memory is to operate in the read-only mode.

Example 24 includes the subject matter of any of Examples 15-23, and wherein determining the number of spare storage cells available in the memory comprises polling the memory for the number of spare storage cells.

Example 25 includes the subject matter of any of Examples 15-24, and wherein determining the number of spare storage cells available in the memory comprises determining a present age of the memory; comparing the present age of the memory to a predefined expected lifetime; and determining the number of spare storage cells based on the comparison of the present age of the memory to the predefined expected lifetime.

Example 26 includes the subject matter of any of Examples 15-25, and one or more machine-readable storage media comprising a plurality of instructions stored thereon that, when executed, cause an apparatus to perform the method of any of Examples 15-25.

Example 27 includes an apparatus comprising means for determining whether a memory of the apparatus is presently operated in a read-only mode due to a presence of an end of life condition; means for determining, in response to a determination that the memory is presently operated in the read-only mode and in response to an action of a host, whether to transition the memory to a temporary write mode; and means for transitioning, in response to a determination to transition the memory to a temporary write mode, the memory to the temporary write mode.

Example 28 includes the subject matter of Example 27, and wherein the action of the host is a drive identification process, the apparatus further comprising means for determining whether the drive identification process has completed; and means for enabling, in response to a determination that the drive identification process has completed, the read-only mode.

Example 29 includes the subject matter of any of Examples 27 and 28, and further comprising means for transmitting a message to the host that the memory is in the read-only mode in response to the determination that the drive identification process has completed.

Example 30 includes the subject matter of any of Examples 27-29, and wherein the activity of the host is a drive identification process, the apparatus further comprising means for receiving a write request associated with the drive identification process performed by the host; and means for determining, in response to the write request, that the host is to perform the drive identification process.

Example 31 includes the subject matter of any of Examples 27-30, and further comprising means for writing temporary data to the memory in response to the write request associated with the drive identification process.

Example 32 includes the subject matter of any of Examples 27-31, and wherein the memory is non-volatile memory and the apparatus further includes a buffer, the method further comprising means for writing temporary data to the buffer in response to the write request associated with the drive identification process.

Example 33 includes the subject matter of any of Examples 27-32, and further comprising means for writing temporary data to the memory in response to the write request associated with the drive identification process; means for suspending context saves; and means for storing an indicator to not perform a power loss recovery, after the temporary data is written.

Example 34 includes the subject matter of any of Examples 27-33, and further comprising means for determining whether a power cycle has occurred; and means for determining, in response to a determination that the power cycle has occurred, that the host is to perform a drive identification process.

Example 35 includes the subject matter of any of Examples 27-34, and wherein the means for determining whether the memory is to operate in a read-only mode due to a presence of an end of life condition comprises means for determining a number of spare storage cells available in the memory; means for comparing the determined number of spare storage cells to a predefined threshold number of spare storage cells; and means for determining, in response to a determination that the number of spare storage cells does not satisfy the predefined threshold number of spare storage cells, that the memory is to operate in the read-only mode.

Example 36 includes the subject matter of any of Examples 27-35, and wherein the means for determining the number of spare storage cells available in the memory comprises means for polling the memory for the number of spare storage cells.

Example 37 includes the subject matter of any of Examples 27-36, and wherein the means for determining the number of spare storage cells available in the memory comprises means for determining a present age of the memory; means for comparing the present age of the memory to a predefined expected lifetime; and means for determining the number of spare storage cells based on the comparison of the present age of the memory to the predefined expected lifetime.

Example 38 includes a compute device comprising a data storage device that includes a memory that includes a plurality of storage cells; a processor coupled to the data storage device, wherein the processor is configured to determine whether the storage device is to operate in a read-only mode due to a presence of an end of life condition; determine, in response to a determination that the storage device is to operate in a read-only mode and in response to a determination that the compute device is to perform an activity that includes a write operation, to transition the storage device to a temporary write mode; and transition, in response to a determination to transition the memory to a temporary write mode, the memory to the temporary write mode.

Example 39 includes the subject matter of Example 38, and wherein to transition the memory to the temporary write mode comprises to generate and transmit a request to the data storage device to disable the read-only mode.

Example 40 includes the subject matter of any of Examples 38 and 39, and wherein the processor is further to determine whether the drive identification process has completed; and enable, in response to a determination that the drive identification process has completed, the read-only mode.

Example 41 includes the subject matter of any of Examples 38-40, and wherein to enable the read-only mode comprises to generate and transmit a request to the data storage device to enable the read-only mode.

Example 42 includes the subject matter of any of Examples 38-41, and by a processor of an apparatus, whether a storage device of the apparatus is to operate in a read-only mode due to a presence of an end of life condition; determining, by the processor, in response to a determination that the storage device is to operate in a read-only mode and in response to a determination that the compute device is to perform an activity that includes a write operation, to transition the storage device to a temporary write mode; and transitioning, by the processor and in response to a determination to transition the memory to a temporary write mode, the memory to the temporary write mode.

Example 43 includes the subject matter of any of Examples 38-42, and wherein transitioning the memory to the temporary write mode comprises generating and transmitting a request to the data storage device to disable the read-only mode.

Example 44 includes the subject matter of any of Examples 38-43, and further comprising determining, by the processor, whether the drive identification process has completed; and enabling, by the processor and in response to a determination that the drive identification process has completed, the read-only mode.

Example 45 includes the subject matter of any of Examples 38-44, and wherein enabling the read-only mode comprises generating and transmitting a request to the data storage device to enable the read-only mode.

Example 46 includes the subject matter of any of Examples 38-45, and one or more machine-readable storage media comprising a plurality of instructions stored thereon that, when executed, cause a compute device to perform the method of any of Examples 42-45.

Example 47 includes a compute device comprising means for determining whether a storage device of the apparatus is to operate in a read-only mode due to a presence of an end of life condition; means for determining in response to a determination that the storage device is to operate in a read-only mode and in response to a determination that the compute device is to perform an activity that includes a write operation, to transition the storage device to a temporary write mode; and means for transitioning, in response to a determination to transition the memory to a temporary write mode, the memory to the temporary write mode.

Example 48 includes the subject matter of Example 47, and wherein the means for transitioning the memory to the temporary write mode comprises means for generating and transmitting a request to the data storage device to disable the read-only mode.

Example 49 includes the subject matter of any of Examples 47 and 48, and further comprising means for determining whether the drive identification process has completed; and means for enabling, in response to a determination that the drive identification process has completed, the read-only mode.

Example 50 includes the subject matter of any of Examples 47-49, and wherein the means for enabling the read-only mode comprises means for generating and transmitting a request to the data storage device to enable the read-only mode.

1. An apparatus comprising:
a memory that includes a plurality of storage cells; and
a controller to manage read and write operations of the memory, wherein the controller is to:
determine whether the memory is presently operated in a read-only mode due to a presence of an end of life condition;
determine, in response to a determination that the memory is presently operated in the read-only mode and in response to an action of a host, whether to transition the memory to a temporary write mode; and
transition, in response to a determination to transition the memory to a temporary write mode, the memory to the temporary write mode.

2. The apparatus of claim 1, wherein the action of the host is a drive identification process, and the controller is further to:
determine whether the drive identification process has completed; and
enable, in response to a determination that the drive identification process has completed, the read-only mode.

3. The apparatus of claim 2, wherein the controller is further to transmit a message to the host that the memory is in the read-only mode in response to the determination that the drive identification process has completed.

4. The apparatus of claim 1, wherein the activity of the host is a drive identification process, and the controller is further to:
receive a write request associated with the drive identification process performed by the host; and
determine, in response to the write request, that the host is to perform the drive identification process.

5. The apparatus of claim 4, wherein the controller is further to write temporary data to the memory in response to the write request associated with the drive identification process.

6. The apparatus of claim 4, wherein the memory is non-volatile memory, the apparatus further comprising a buffer, wherein the controller is further to write temporary data to the buffer in response to the write request associated with the drive identification process.

7. The apparatus of claim 4, wherein the controller is further to:
write temporary data to the memory in response to the write request associated with the drive identification process;
suspend context saves; and
store an indicator to not perform a power loss recovery, after the temporary data is written.

8. The apparatus of claim 1, wherein to the controller is further to:
determine whether a power cycle has occurred; and
determine, in response to a determination that the power cycle has occurred, that the host is to perform a drive identification process.

9. The apparatus of claim 1, wherein to determine whether the memory is to operate in a read-only mode due to a presence of an end of life condition comprises to:
determine a number of spare storage cells available in the memory;
compare the determined number of spare storage cells to a predefined threshold number of spare storage cells; and
determine, in response to a determination that the number of spare storage cells does not satisfy the predefined threshold number of spare storage cells, that the memory is to operate in the read-only mode.

10. The apparatus of claim 9, wherein to determine the number of spare storage cells available in the memory comprises to poll the memory for the number of spare storage cells.

11. The apparatus of claim 9, wherein to determine the number of spare storage cells available in the memory comprises to:
determine a present age of the memory;
compare the present age of the memory to a predefined expected lifetime; and
determine the number of spare storage cells based on the comparison of the present age of the memory to the predefined expected lifetime.

12. The apparatus of claim 1, wherein the memory is non-volatile memory.

13. One or more machine-readable storage media comprising a plurality of instructions stored thereon that, when executed, cause an apparatus to:
determine whether a memory of the apparatus is presently operated in a read-only mode due to a presence of an end of life condition;
determine, in response to a determination that the memory is presently operated in the read-only mode and in response to an action of a host, whether to transition the memory to a temporary write mode; and
transition, in response to a determination to transition the memory to a temporary write mode, the memory to the temporary write mode.

14. The one or more machine-readable storage media of claim 13, wherein the action of the host is a drive identification process and the plurality of instructions, when executed, further cause the apparatus to:
determine whether the drive identification process has completed; and
enable, in response to a determination that the drive identification process has completed, the read-only mode.

15. The one or more machine-readable storage media of claim 14, wherein the plurality of instructions, when executed, further cause the apparatus to transmit a message to the host that the memory is in the read-only mode in response to the determination that the drive identification process has completed.

16. The one or more machine-readable storage media of claim 13, wherein the activity of the host is a drive identification process and the plurality of instructions, when executed, further cause the apparatus to:
receive a write request associated with the drive identification process performed by the host; and
determine, in response to the write request, that the host is to perform the drive identification process.

17. The one or more machine-readable storage media of claim 16, wherein the plurality of instructions, when executed, further cause the apparatus to write temporary data to the memory in response to the write request associated with the drive identification process.

18. The one or more machine-readable storage media of claim 16, wherein the memory is non-volatile memory and the apparatus further includes a buffer, and the plurality of instructions, when executed, further cause the apparatus to write temporary data to the buffer in response to the write request associated with the drive identification process.

19. The one or more machine-readable storage media of claim 16, wherein the plurality of instructions, when executed, further cause the apparatus to:
write temporary data to the memory in response to the write request associated with the drive identification process;
suspend context saves; and
store an indicator to not perform a power loss recovery, after the temporary data is written.

20. The one or more machine-readable storage media of claim 13, wherein the plurality of instructions, when executed, further cause the apparatus to:
determine whether a power cycle has occurred; and
determine, in response to a determination that the power cycle has occurred, that the host is to perform a drive identification process.

21. The one or more machine-readable storage media of claim 13, wherein to determine whether the memory is to operate in a read-only mode due to a presence of an end of life condition comprises to:
determine a number of spare storage cells available in the memory;
compare the determined number of spare storage cells to a predefined threshold number of spare storage cells; and
determine, in response to a determination that the number of spare storage cells does not satisfy the predefined threshold number of spare storage cells, that the memory is to operate in the read-only mode.

22. The one or more machine-readable storage media of claim 21, wherein to determine the number of spare storage cells available in the memory comprises to pole the memory for the number of spare storage cells.

23. A method comprising:
determining, by a controller of an apparatus, whether a memory of the apparatus is presently operated in a read-only mode due to a presence of an end of life condition;
determining, by the controller and in response to a determination that the memory is presently operated in the read-only mode and in response to an action of a host, whether to transition the memory to a temporary write mode; and
transitioning, by the controller and in response to a determination to transition the memory to a temporary write mode, the memory to the temporary write mode.

24. The method of claim 23, wherein the action of the host is a drive identification process, the method further comprising:
determining, by the controller, whether the drive identification process has completed; and
enabling, by the controller and in response to a determination that the drive identification process has completed, the read-only mode.

25. The method of claim 24, further comprising transmitting, by the controller, a message to the host that the memory is in the read-only mode in response to the determination that the drive identification process has completed.
